(19) United States
(12) Patent Application Publication
(10) Pub. No.: US 2025/0112271 A1
(43) Pub. Date: Apr. 3, 2025

(54) FLUORINATED PHOSPHATE ESTER ADDITIVES FOR ELECTROLYTES OF BATTERIES INCLUDING LITHIUM- AND MANGANESE-RICH POSITIVE ELECTRODES

(71) Applicant: GM GLOBAL TECHNOLOGY OPERATIONS LLC, Detroit, MI (US)

(72) Inventors: Chuanlong Wang, Troy, MI (US); Xiaosong Huang, Novi, MI (US)

(21) Appl. No.: 18/354,196

(22) Filed: Jul. 18, 2023

(51) Int. Cl. H01M 10/0567; H01M 4/36; H01M 4/48; H01M 4/505; H01M 4/525; H01M 4/587; H01M 10/0525; H01M 10/0568; H01M 10/0569

(52) U.S. Cl. CPC H01M 10/0567; H01M 4/364; H01M 4/483; H01M 4/505; H01M 4/525; H01M 4/587; H01M 10/0525; H01M 10/0568; H01M 10/0569; H01M 2004/027; H01M 2004/028; H01M 2220/20; H01M 2300/0034; H01M 2300/0037; H01M 2300/0042

(57) ABSTRACT

A battery that cycles lithium ions includes a positive electrode and an electrolyte infiltrating the positive electrode. The positive electrode includes an electroactive material including a layered lithium transition metal oxide. The electrolyte includes an organic solvent, a lithium salt, and a fluorinated phosphate ester additive. The fluorinated phosphate ester includes at least one of: (i) a chemical compound comprising a phosphate group attached to two or three branched-chain fluorocarbon groups, or (ii) a chemical compound comprising a cyclic phosphate group attached to a fluorocarbon group.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to additives for electrolytes of batteries that facilitate formation of protective interphase layers on surfaces of the electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high dielectric constant (correlated with a high ability to dissolve salts), good thermal stability, a wide electrochemical stability window, ability to form a stable ionically conductive solid electrolyte interphase on the surface of the positive electrode and/or the negative electrode, and chemical compatibility with other components of the batteries.

### SUMMARY

A battery that cycles lithium ions, in accordance with one or more embodiments of the present disclosure, comprises a positive electrode and an electrolyte infiltrating the positive electrode. The positive electrode comprises an electroactive material comprising a layered lithium transition metal oxide. The electrolyte comprises an organic solvent, a lithium salt in the organic solvent, and a fluorinated phosphate ester additive in the organic solvent. The fluorinated phosphate ester additive comprises at least one of: (i) a chemical compound comprising a phosphate group attached to two or three branched-chain fluorocarbon groups, or (ii) a chemical compound comprising a cyclic phosphate group attached to a fluorocarbon group.

The fluorinated phosphate ester additive may comprise a fluorinated phosphate triester having the formula (1):

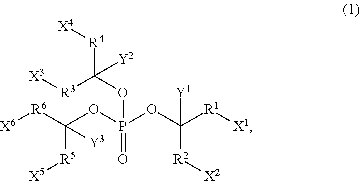

where X¹, X², X³, X⁴, X⁵, and X⁶ are each individually a fluorocarbon group, R¹, R², R³, R⁴, R⁵, and R⁶ are each individually a fluorinated or unfluorinated bivalent hydrocarbon group, and Y¹, Y², and Y³ are each individually hydrogen (H) or fluorine (F).

The fluorinated phosphate ester additive may comprise tris(1,1,1,3,3,3-hexafluoropropan-2-yl) phosphate, tris(1,1,1,5,5,5-hexafluoropentan-3-yl) phosphate, tris(1,1,1,2,3,3,3-heptafluoropropan-2-yl) phosphate, or a combination thereof.

The fluorinated phosphate ester additive may comprise a fluorinated cyclic phosphate ester having the formula (2):

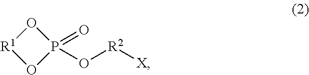

where R¹ is an unfluorinated bivalent hydrocarbon group, R² is a fluorinated or unfluorinated bivalent hydrocarbon group, and X is a fluorocarbon group.

The fluorinated phosphate ester additive may comprise 2-(2,2,2-trifluoroethoxy)-1,3,2-dioxaphospholane 2-oxide.

The fluorinated phosphate ester additive may constitute, by weight, greater than or equal to about 0.5% to less than or equal to about 2.5% of the electrolyte.

In aspects, the electroactive material of the positive electrode may comprise a layered lithium- and manganese-rich transition metal oxide and the organic solvent may comprise a mixture of fluoroethylene carbonate (FEC) and diethyl carbonate (DEC). In such case, the lithium salt may comprise lithium hexafluorophosphate (LiPF₆) and the electrolyte may further comprise lithium difluorophosphate (LiPO₂F₂). The fluorinated phosphate ester additive may constitute, by weight, greater than or equal to about 0.5% to less than or equal to about 1.5% of the electrolyte, and the LiPO₂F₂ may constitute, by weight, greater than or equal to about 0.5% to less than or equal to about 1.5% of the electrolyte.

In aspects, the electroactive material of the positive electrode may comprise a layered lithium nickel-rich transition metal oxide and the organic solvent may comprise a mixture of ethylene carbonate (EC) and dimethyl carbonate (DMC). In such case, the lithium salt may comprise lithium hexafluorophosphate (LiPF₆) and lithium difluoro(oxalato)borate (LiDFOB), and the electrolyte may further comprise fluoroethylene carbonate (FEC) and vinylene carbonate (VC). The fluorinated phosphate ester additive may constitute, by weight, greater than or equal to about 1.5% to less than or equal to about 2.5% of the electrolyte, the LiDFOB may constitute, by weight, greater than or equal to about 0.5% to less than or equal to about 1.5% of the electrolyte, the FEC may constitute, by weight, greater than or equal to about 1.5% to less than or equal to about 2.5% of the electrolyte, and the VC may constitute, by weight, greater than or equal to about 0.5% to less than or equal to about 1.5% of the electrolyte.

During cycling of the battery, the fluorinated phosphate ester additive may decompose and form an interphase layer on surfaces of the electroactive material of the positive electrode that isolates the electroactive material from physical contact with the electrolyte.

The battery may further comprise an interphase layer formed in situ on the electroactive material of the positive electrode during cycling of the battery. The interphase layer may comprise the electrochemical decomposition products of the fluorinated phosphate ester additive. The interphase layer may physically isolate the electroactive material of the positive electrode from contact with the electrolyte.

A battery that cycles lithium ions, in accordance with one or more embodiments of the present disclosure, comprises a positive electrode, a negative electrode, and an electrolyte infiltrating the positive electrode and the negative electrode. The positive electrode comprises an electroactive material comprising a layered lithium transition metal oxide. The negative electrode comprises an electroactive material comprising silicon oxide, lithiated silicon oxide, graphite, or a combination thereof. The electrolyte comprises an organic solvent, a lithium salt in the organic solvent, and a fluorinated phosphate ester additive in the organic solvent. The organic solvent comprises a cyclic carbonate and a linear carbonate. The fluorinated phosphate ester additive comprises at least one of: (i) a chemical compound comprising a phosphate group attached to two or three branched-chain fluorocarbon groups, or (ii) a chemical compound comprising a cyclic phosphate group attached to a fluorocarbon group.

The fluorinated phosphate ester additive may comprise a fluorinated phosphate triester having the formula (1):

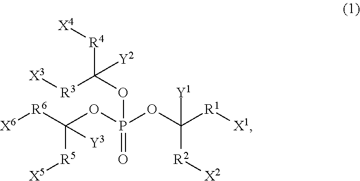

where X¹, X², X³, X⁴, X⁵, and X⁶ are each individually a fluorocarbon group, R¹, R², R³, R⁴, R⁵, and R⁶ are each individually a fluorinated or unfluorinated bivalent hydrocarbon group, and Y¹, Y², and Y³ are each individually hydrogen (H) or fluorine (F).

The fluorinated phosphate ester additive may comprise tris(1,1,1,3,3,3-hexafluoropropan-2-yl) phosphate, tris(1,1,1,5,5,5-hexafluoropentan-3-yl) phosphate, tris(1,1,1,2,3,3,3-heptafluoropropan-2-yl) phosphate, or a combination thereof.

The fluorinated phosphate ester additive may comprise a fluorinated cyclic phosphate ester having the formula (2):

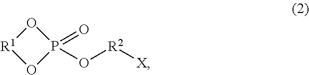

where R¹ is an unfluorinated bivalent hydrocarbon group, R² is a fluorinated or unfluorinated bivalent hydrocarbon group, and X is a fluorocarbon group.

The fluorinated phosphate ester additive may comprise 2-(2,2,2-trifluoroethoxy)-1,3,2-dioxaphospholane 2-oxide.

The fluorinated phosphate ester additive may constitute, by weight, greater than or equal to about 0.5% to less than or equal to about 2.5% of the electrolyte.

In aspects, the electroactive material of the positive electrode may comprise a layered lithium- and manganese-rich transition metal oxide, the organic solvent may comprise a mixture of fluoroethylene carbonate (FEC) and diethyl carbonate (DEC), the lithium salt may comprise lithium hexafluorophosphate (LiPF₆), and the electrolyte may further comprise lithium difluorophosphate (LiPO₂F₂). In such case, the fluorinated phosphate ester additive may constitute, by weight, greater than or equal to about 0.5% to less than or equal to about 1.5% of the electrolyte, and the LiPO₂F₂ may constitute, by weight, greater than or equal to about 0.5% to less than or equal to about 1.5% of the electrolyte.

In aspects, the electroactive material of the positive electrode may comprise a layered lithium nickel-rich transition metal oxide, the organic solvent may comprise a mixture of ethylene carbonate (EC) and dimethyl carbonate (DMC), the lithium salt may comprise lithium hexafluorophosphate (LiPF₆) and lithium difluoro(oxalato)borate (LiDFOB), and the electrolyte may further comprise fluoroethylene carbonate (FEC) and vinylene carbonate (VC). In such case, the fluorinated phosphate ester additive may constitute, by weight, greater than or equal to about 1.5% to less than or equal to about 2.5% of the electrolyte, the LiDFOB may constitute, by weight, greater than or equal to about 0.5% to less than or equal to about 1.5% of the electrolyte, the FEC may constitute, by weight, greater than or equal to about 1.5% to less than or equal to about 2.5% of the electrolyte, and the VC may constitute, by weight, greater than or equal to about 0.5% to less than or equal to about 1.5% of the electrolyte.

The battery may further comprise a first interphase layer disposed on the electroactive material of the positive electrode that physically isolates the electroactive material of the positive electrode from contact with the electrolyte and a second interphase layer disposed on the electroactive material of the negative electrode that physically isolates the electroactive material of the negative electrode from contact with the electrolyte. The first interphase layer and the second interphase layer may be formed in situ during cycling of the battery. The first interphase layer and the second interphase layer may comprise decomposition products of the fluorinated phosphate ester additive.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

In the drawings, reference numbers may be reused to identify similar and/or identical elements.

### DETAILED DESCRIPTION

The presently disclosed electrolytes are formulated for use in batteries that cycle lithium ions and include layered lithium transition metal oxides as positive electrode materials that may operate at ultra-high voltages (e.g., >4.4 V versus Li+/Li). The presently disclosed electrolytes comprise a fluorinated phosphate ester additive that is formulated to decompose during cycling of the batteries to form protective interphase layers surfaces of the positive and negative electrode materials. The protective interphase layers formed by the fluorinated phosphate ester additive help isolate the positive and negative electrode materials from physical contact with the electrolyte, which may help improve the cycling stability and capacity retention of the battery, for example, by preventing undesirable chemical reactions from occurring between the positive and negative electrode materials and the electrolyte during cycling of the battery.

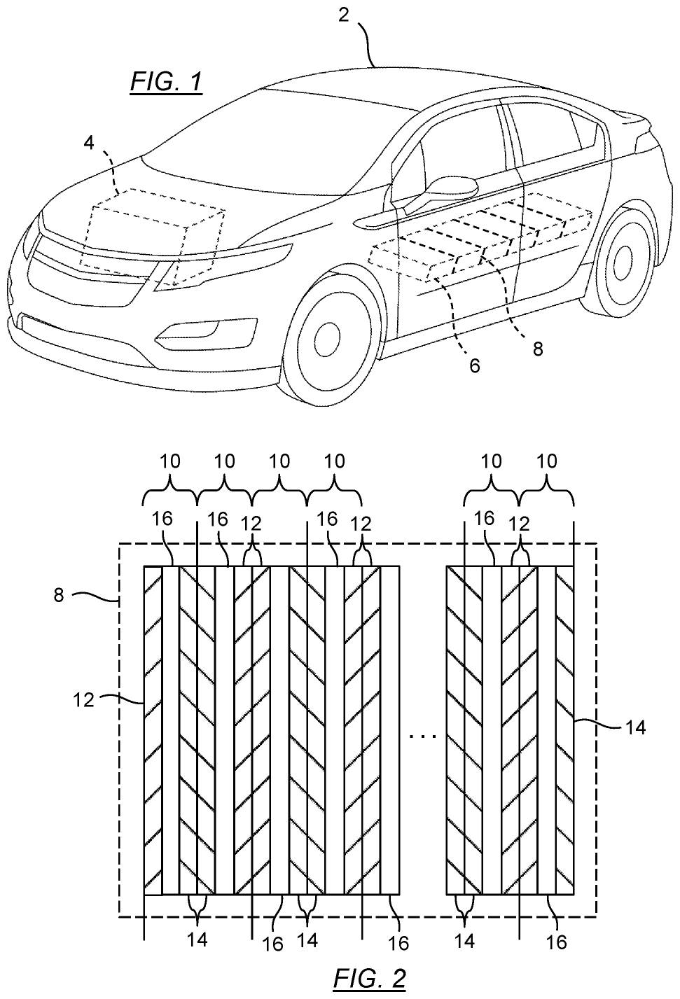

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

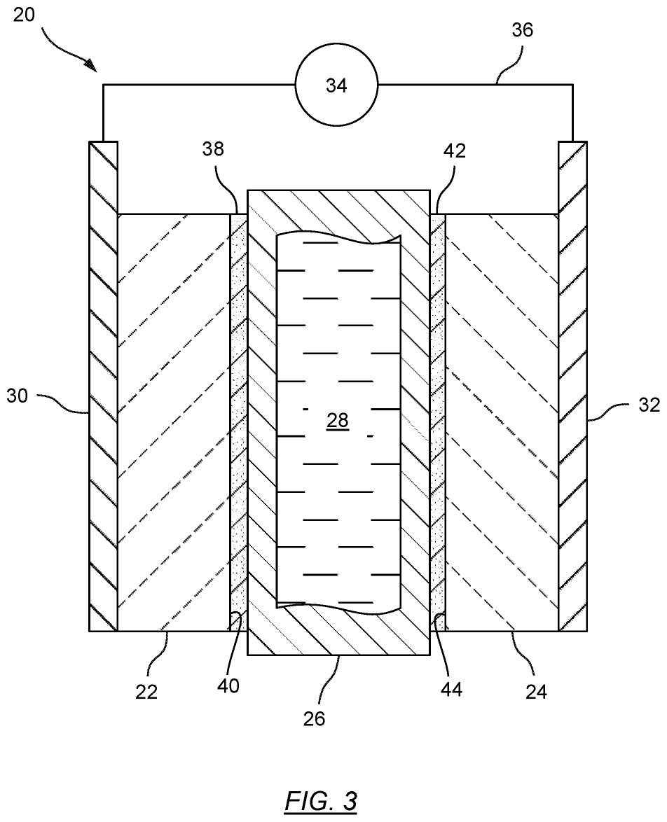

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that wets surfaces of the negative electrode 22, the positive electrode 24, and the separator 26. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous redox reactions within the battery 20 and the release of lithium ions and electrons at the negative electrode 22. The released lithium ions travel from the negative electrode 22 to the positive electrode 24 through the separator 26 and the electrolyte 28, and the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is configured to store and release lithium ions during charge and discharge of the battery 20. The negative electrode 22 may be in the form of a continuous layer of material disposed on a major surface of the negative electrode current collector 30. The negative electrode 22 is configured to store and release lithium ions to facilitate charge and discharge, respectively, of the battery 20. To accomplish this, the negative electrode 22 includes one or more electrochemically active (electroactive) materials that can facilitate the storage and release of lithium ions by undergoing a reversible redox reaction with lithium during charge and discharge of the battery 20. The electroactive material may constitute, by weight, greater than or equal to about 85%, or optionally about 90%, to less than or equal to about 99% of the negative electrode 22.

The electroactive material of the negative electrode 22 may comprise silicon, a silicon oxide-based material, a lithiated silicon oxide-based material, and/or a carbon-based material (e.g., graphite). For example, the electroactive material of the negative electrode 22 may comprise silicon oxide, SiOₓ, where x is greater than zero (0) and less than or equal to 2. In aspects, the electroactive material of the negative electrode 22 may comprise lithiated silicon oxide, Li_{y}SiOₓ, where x is greater than zero (0) and less than or equal to 2 and y is greater than zero (0) and less than or equal to 1. In some aspects, the electroactive material of the negative electrode 22 may comprise a silicon oxide-based material (e.g., Si, SiOₓ, and/or Li_{y}SiOₓ) and a carbon-based material (e.g., graphite). In such case, the silicon oxide-based material may constitute, by weight, greater than or equal to about 10% to less than or equal to about 70%, or optionally less than or equal to about 30% of the electroactive material of the negative electrode 22 and the carbon-based material (e.g., graphite) may constitute, by weight, greater than or equal to about 30%, or optionally about 70%, to less than or equal to about 90% of the electroactive material of the negative electrode 22.

In some aspects, the negative electrode 22 may be porous and the electroactive material of the negative electrode 22 may be a particulate material. In such case, particles of the electroactive material of the negative electrode 22 may be intermingled with a polymer binder and/or an electrically conductive material. The polymer binder may provide the negative electrode 22 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The electrically conductive material may provide the negative electrode 22 with good electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. In aspects, the negative electrode 22 may comprise an electrically conductive material comprising carbon black.

The positive electrode 24 is configured to store and release lithium ions during discharge and charge of the battery 20. The positive electrode 24 may be in the form of a continuous porous layer disposed on the major surface of the positive electrode current collector 20. The positive electrode 24 comprises one or more electrochemically active (electroactive) materials that can undergo a reversible redox reaction with lithium at a higher electrochemical potential than the electroactive material of the negative electrode 22 such that an electrochemical potential difference exists between the positive and negative electrodes 12, 14. For example, the electroactive material of the positive electrode 24 may comprise an intercalation host material that can undergo the reversible insertion or intercalation of lithium ions. In such case, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). The electroactive material of the positive electrode 24 may constitute, by weight, greater than or equal to about 80%, optionally about 90%, optionally about 95% to less than or equal to about 99%, or optionally about 98% of the positive electrode 24.

In aspects, the electroactive material of the positive electrode 24 may comprise a layered lithium manganese-rich transition metal oxide represented by the formula LiMeO₂ and/or Li₂MeO₃, where Me comprises, by weight, greater than or equal to about 50% manganese (Mn). In aspects, the electroactive material of the positive electrode 24 may comprise a layered lithium- and manganese-rich transition metal oxide represented by the formula Li₁₊ₓMe₁₋ₓO₂ (where 0<x≤0.33), where Me comprises, by weight, greater than or equal to about 50% manganese (Mn). In some aspects, the electroactive material of the positive electrode 24 may comprise a layered lithium- and manganese-rich oxide represented by the formula Li₂MnO₃. In aspects, the electroactive material of the positive electrode 24 may comprise a layered lithium nickel-rich transition metal oxide represented by the formula LiMeO₂ and/or Li₂MeO₃, where Me comprises, by weight, greater than or equal to about 50% nickel (Ni). In aspects, the electroactive material of the positive electrode 24 may comprise a layered lithium- and nickel-rich transition metal oxide represented by the formula Li₁₊ₓMe₁₋ₓO₂ (where 0<x≤0.33), where Me comprises, by weight, greater than or equal to about 50% nickel (Ni).

In aspects, the electroactive material of the positive electrode 24 may comprise lithium manganese iron phosphate (LMFP), lithium iron phosphate (LFP), spinel lithium manganese oxide (LiMn₂O₄, LMO), high voltage spinel (LiNi_{0.5}Mn_{1.5}O₄, LNMO), lithium nickel cobalt manganese aluminum oxide (NCMA), lithium nickel manganese cobalt oxide (NMC), lithium nickel manganese oxide (LNMO), e.g., LiNi_{0.5}Mn_{1.5}O₄ and/or Li_{1.2}Ni_{0.2}Mn_{0.6}O₂, lithium nickel cobalt aluminum oxide (NCA), or a combination thereof.

Like the electroactive material of the negative electrode 22, the electroactive material of the positive electrode 24 may be a particulate material and particles of the electroactive material of the positive electrode 24 may be intermingled with a polymer binder and/or particles of an electrically conductive material. The same polymer binders and/or electrically conductive materials disclosed above with respect to the negative electrode 22 may be used in the positive electrode 24. In aspects, the positive electrode 24 may comprise a polymer binder comprising polyvinylidene fluoride.

The separator 26 physically separates and electrically isolates the negative and positive electrodes 22, 24 from each other while permitting lithium ions to pass therethrough. The separator 26 has an open microporous structure and may comprise an organic and/or inorganic material. For example, the separator 26 may comprise a polymer or a combination of polymers. For example, the separator 26 may comprise one or more polyolefins, e.g., polyethylene (PE), polypropylene (PP), polyamide (PA), poly(tetrafluoroethylene) (PTFE), polyvinylidene fluoride (PVDF), and/or poly(vinyl chloride) (PVC). In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive provides a medium for the conduction of lithium ions between the negative and positive electrodes 22, 24 and is formulated to provide the battery 20 with enhanced cycling stability. The electrolyte 28 comprises an organic solvent, a lithium salt, and a fluorinated phosphate ester additive. As shown in FIG. 3, the fluorinated phosphate ester additive is formulated to assist in formation of a first interphase layer 38 on surfaces 40 of the negative electrode 22 and a second interphase layer 42 on surfaces 44 of the positive electrode 24.

The organic solvent may comprise a nonaqueous aprotic organic solvent or a mixture of nonaqueous aprotic organic solvents. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)), linear carbonates (e.g., dimethyl carbonate (DMC), diethyl carbonate (DEC), ethyl methyl carbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), and combinations thereof. The organic solvent may constitute, by weight, greater than or equal to about 70% to less than or equal to about 90% of the electrolyte 28. In aspects, the organic solvent may comprise a mixture of a cyclic carbonate and a linear carbonate. For example, the organic solvent may comprise a mixture of FEC and DEC. In such case, the volumetric ratio of FEC to DEC in the organic solvent may be about 1:4. As another example, the organic solvent may comprise a mixture of EC and DMC. In such case, the volumetric ratio of EC to DMC in the organic solvent may be about 3:7. In aspects where the organic solvent comprises a mixture of EC and DMC, the organic solvent may further comprise FEC and VC. In such case, the FEC may constitute, by weight, greater than or equal to about 1% to less than or equal to about 3% of the electrolyte 28 and the VC may constitute, by weight, greater than or equal to about 0.5% to less than or equal to about 1.5% of the electrolyte 28. For example, in aspects, the FEC may constitute, by weight, about 2% and the VC may constitute, by weight, about 1% of the electrolyte 28.

The lithium salt is soluble in the organic solvent and provides a passage for lithium ions through the electrolyte 28. The lithium salt may comprise an inorganic lithium salt, an organic lithium salt, or a combination thereof. Examples of inorganic lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium tetraphenylborate (LiB(C₆H₅)₄), lithium bis(oxalato)borate (LiB(C₂O₄)₂) (LiBOB), lithium difluoro(oxalato)borate (LiBF₂(C₂O₄)) (LiDFOB), and combinations thereof. The lithium salt may be dissolved in the organic solvent at a concentration of greater than or equal to about 0.5 Molar to less than or equal to about 1.5 Molar. In aspects, the lithium salt may be dissolved in the organic solvent at a concentration of about 1 Molar. The lithium salt may constitute, by weight, greater than or equal to about 5% to less than or equal to about 20% of the electrolyte 28. In aspects, the lithium salt may comprise LiPF₆. In aspects, the lithium salt may comprise LiPF₆ and LiPO₂F₂. In such case, the LiPO₂F₂ may constitute, by weight, greater than or equal to about 0.1%, or optionally about 0.5%, to less than or equal to about 3%, or optionally about 1.5%, of the electrolyte 28. In aspects, the LiPO₂F₂ may constitute, by weight, about 1% of the electrolyte 28. In aspects, the lithium salt may comprise LiPF₆ and LiDFOB. In such case, the LiDFOB may constitute, by weight, greater than or equal to about 0.1%, or optionally about 0.5%, to less than or equal to about 3%, or optionally about 1.5%, of the electrolyte 28. In aspects, the LiDFOB may constitute, by weight, about 1% of the electrolyte 28.

The fluorinated phosphate ester additive is formulated to assist in formation of the first interphase layer 38 and the second interphase layer 42 during initial charge and/or cycling of the battery 20.

The fluorinated phosphate ester additive is a chemical compound comprising a monophosphate group attached to two or three fluorocarbon groups (i.e., fluoroalkyl groups, fluoroalkenyl groups, fluoroalkynyl groups, fluoroaryl groups, or a combination thereof). A fluorocarbon group or fluorinated hydrocarbon group is a hydrocarbon group in which at least one of the hydrogen (H) atoms has been replaced with a fluorine (F) atom. The fluorocarbon group may be polyfluorinated, in which more than one of the H atoms has been replaced with a F atom, or the fluorocarbon group may be perfluorinated, in which all of the H atoms have been replaced with F atoms. A ratio of fluorine (F) to phosphorus (P) (F to P) in the fluorinated phosphate ester additive may be greater than or equal to about 3 to 1, optionally greater than or equal to about 12 to 1, or optionally greater than or equal to about 18 to 1.

In aspects, the fluorinated phosphate ester additive may be a chemical compound comprising a phosphate group attached to two or three branched-chain fluorocarbon groups. For example, the fluorinated phosphate ester additive may be a fluorinated phosphate triester having the following formula (1):

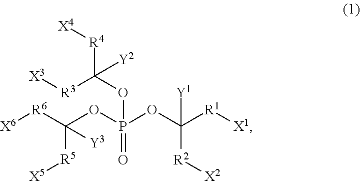

where X¹, X², X³, X⁴, X⁵, and X⁶ are each individually a fluorocarbon group, R¹, R², R³, R⁴, R⁵, and R⁶ are each individually a fluorinated or unfluorinated bivalent hydrocarbon group, and Y¹, Y², and Y³ are each individually hydrogen (H) or fluorine (F).

X¹, X², X³, X⁴, X⁵, and X⁶ may each individually be a polyfluorinated or perfluorinated C₁-C₁₀ straight-chain or branched chain alkyl group, alkenyl group, alkynyl group, aryl group, or a combination thereof. Examples of straight-chain C₁-C₁₀ alkyl groups include methyl groups (—CH₃), ethyl groups (—CH₂CH₃), propyl groups (—CH₂CH₂CH₃), and butyl groups (—CH₂CH₂CH₂CH₃). Examples of branched-chain C₁-C₁₀ alkyl groups include isopropyl groups (—CH(CH₃)₂), isobutyl groups (—CH₂—CH(CH₃)₂), sec-butyl groups (—(CH₃)CH—CH₂—CH₃), tert-butyl groups (—C(CH₃)₃), isopentyl groups (—(CH₂)₂—CH(CH₃)₂), and tert-pentyl groups (—(CH₃)₂C—CH₂—CH₃). Alkenyl groups are aliphatic hydrocarbon groups with at least one carbon-carbon double bond (C═C) and are formed when a hydrogen atom is removed from an alkene group. Example alkenyl groups include vinyl groups (—CH═CH₂), allyl groups (—CH₂—HC═CH₂), propenyl groups (—CH═CHCH₃), isopropenyl (—(CH₃)C═CH₂), ethylidene groups (═CH—CH₃), isopropylidene groups (═C(CH₃)₂). Examples of aryl groups include phenyl groups (—C₆H₅), benzyl groups (—CH₂—C₆H₅), benzylidene groups (═CH—C₆H₅), styryl groups (—CH═CH—C₆H₅), phenethyl groups (—CH₂—CH₂—C₆H₅), cinnamyl groups (—CH₂—CH═CH—C₆H₅), benzhydryl groups (—CH(C₆H₅)₂). In aspects, X¹, X², X³, X⁴, X⁵, and X⁶ may each individually be trifluoromethyl groups (—CF₃).

R¹, R², R³, R⁴, R⁵, and R⁶ may each individually be a fluorinated or unfluorinated C₁-C₃ straight-chain bivalent hydrocarbon group. For example, R¹, R², R³, R⁴, R⁵, and R⁶ may each individually be a fluorinated or unfluorinated methylene group (—CH₂—), ethylene group (—CH₂—CH₂—), trimethylene group (—CH₂—CH₂—CH₂—), vinylene group (—HC═CH—), propenylene group (—H₂C═C═CH—), or propylene group (—CH(CH₃)CH₂—). In aspects, R¹, R², R³, R⁴, R⁵, and R⁶ may each individually be a methylene group.

Examples of fluorinated phosphate triesters of formula (1) include tris(1,1,1,3,3,3-hexafluoropropan-2-yl) phosphate (CAS No. 66489-68-7) (THFPP), tris(1,1,1,5,5,5-hexafluoropentan-3-yl) phosphate (PubChem CID 87107505), tris(1,1,1,2,3,3,3-heptafluoropropan-2-yl) phosphate (PubChem CID 87090955), and combinations thereof.

In aspects, the fluorinated phosphate ester additive may be a chemical compound comprising a cyclic phosphate group attached to a fluorocarbon group. For example, the fluorinated phosphate ester additive may be a fluorinated cyclic phosphate ester having the following formula (2):

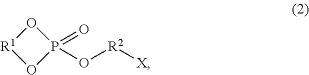

where R¹ is an unfluorinated bivalent hydrocarbon group, R² is a fluorinated or unfluorinated bivalent hydrocarbon group, and X is a fluorocarbon group. For example, R¹ may be a methylene group (—CH₂—), ethylene group (—CH₂—CH₂—), trimethylene group (—CH₂—CH₂—CH₂—), vinylene group (—HC═CH—), propenylene group (—H₂C═C═CH—), or propylene group (—CH(CH₃)CH₂—). In aspects, R¹ may be an ethylene group. R² may be a fluorinated or unfluorinated methylene group (—CH₂—), ethylene group (—CH₂—CH₂—), trimethylene group (—CH₂—CH₂—CH₂—), vinylene group (—HC═CH—), propenylene group (—H₂C═C═CH—), or propylene group (—CH(CH₃)CH₂—). In aspects, R² may be a methylene group. X may be a polyfluorinated or perfluorinated C₁-C₁o straight-chain or branched chain alkyl group, alkenyl group, alkynyl group, aryl group, or a combination thereof. In aspects, X may be a trifluoromethyl group (—CF₃).

An example of a fluorinated cyclic phosphate ester having the following formula (2) is 2-(2,2,2-trifluoroethoxy)-1,3,2-dioxaphospholane 2-oxide (CAS No. 67605-68-9) (TEDPO).

The fluorinated phosphate ester additive may constitute, by weight, greater than or equal to about 0.1%, optionally about 0.5%, optionally about 1% to less than or equal to about 5%, optionally about 3%, optionally about 2%, or optionally about 1.5% of the electrolyte 28. In aspects, the fluorinated phosphate ester additive may constitute, by weight, greater than or equal to about 1.5% to less than or equal to about 2.5% of the electrolyte 28.

The first interphase layer 38 and the second interphase layer 42 may inherently form in situ respectively on surfaces 40 of the negative electrode 22 and surfaces 44 of the positive electrode 24 during initial charge and/or cycling of the battery 20, for example, due to chemical reactions between the fluorinated phosphate ester additive in the electrolyte 28 and the electroactive materials of the negative and positive electrodes 22, 24. The first interphase layer 38 may inherently form in situ on surfaces of the negative electrode 22 during initial charge and/or cycling of the battery 20 due to the electrochemical reduction of the fluorinated phosphate ester additive in the electrolyte 28 on surfaces 40 of the electroactive material of the negative electrode 22. The first interphase layer 38 may comprise the electrochemical decomposition products of the fluorinated phosphate ester additive. Without intending to be bound by theory, it is believed that the fluorinated phosphate ester additive may act as a sacrificial component of the electrolyte 28, thereby preventing degradation of the electrolyte 28 during charge and cycling of the battery 20. For example, it is believed that, due to the relatively low energy (more negative) of the lowest unoccupied molecular orbital (LUMO) of the fluorinated phosphate ester additive, the fluorinated phosphate ester additive may be preferentially reduced on surfaces 40 of the negative electrode 22 during initial charge and/or cycling of the battery 20, instead of the other components of the electrolyte 28 (e.g., the organic solvent and/or the lithium salt). For example, the LUMO energy of the fluorinated phosphate ester additive may be less than (more negative than) −0.5 electron volts (eV), or optionally less than or equal to about −0.55 eV. By contrast, other components of the electrolyte 28 may have higher (less negative) LUMO energies, e.g., propylene carbonate=0.63 eV, ethyl methyl carbonate=1.04 eV, and PF₆⁻=0.12 eV. In addition, the LUMO energy of the fluorinated phosphate ester additive may be less than (more negative than) that of unfluorinated phosphate esters, e.g., triethyl phosphate (TEP)=0.86 eV.

The second interphase layer 42 may inherently form in situ on surfaces 44 of the positive electrode 24 during initial charge and/or cycling of the battery 20 due to the electrochemical oxidation of the fluorinated phosphate ester additive in the electrolyte 28 on surfaces 44 of the electroactive materials of the positive electrode 24. The second interphase layer 42 may comprise the electrochemical decomposition products of the fluorinated phosphate ester additive. In particular, the second interphase layer 42 may comprise the reaction products of the electrochemical oxidation of the fluorinated phosphate ester additive.

The first and second interphase layers 38, 42 are electrically insulating and ionically conductive and are configured to help prevent undesirable chemical reactions from occurring between the electrolyte 28 and the respective negative and positive electrodes 22, 24 during cycling of the battery 20. For example, after the first and second interphase layers 38, 42 are formed respectively on surfaces 40, 44 of the negative and positive electrodes 22, 24, the first and second interphase layers 38, 42 may help prevent chemical reactions from occurring between the components of the electrolyte 28 and the negative and positive electrodes 22, 24 during charge and/or discharge of the battery 20. Without intending to be bound by theory, it is believed that formation of the first and second interphase layers 38, 42 may help prevent undesirable chemical reactions from occurring between the electrolyte 28 and the respective negative and positive electrodes 22, 24, without impeding the flow of lithium ions between the electrolyte 28 and the negative and positive electrodes 22, 24.

In FIG. 3, the first interphase layer 38 is depicted as being disposed along an interface between the negative electrode 22 and the separator 26 and the second interphase layer 42 is depicted as being disposed along an interface between the positive electrode 24 and the separator 26; however other arrangements are possible. For example, in aspects where the electroactive material of the negative and positive electrodes 22, 24 are in the form of particulate materials, the first interphase layer 38 may extend at least partway into the negative electrode 22 (toward the negative electrode current collector 30) and may be disposed on surfaces of one or more of the electroactive material particles of the negative electrode 22. Likewise, in aspects, the second interphase layer 42 may extend at least partway into the positive electrode 24 (toward the positive electrode current collector 32) and may be disposed on surfaces of one or more of the electroactive material particles of the positive electrode 24.

The positive and negative electrode current collectors 30, 32 are electrically conductive and provide an electrical connection between the external circuit 36 and their respective positive and negative electrodes 22, 24. In aspects, the positive and negative electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

### EXPERIMENTAL

Full coin cells including different electrolyte formulations were assembled and evaluated using galvanostatic charge and discharge protocols. All cells included a negative electrode consisting of: an electroactive material consisting of a mixture of graphite and silicon oxide, electrically conductive particles, and a polymer binder. Some of the cells included a positive electrode consisting of: an electroactive material consisting of over lithiated nickel manganese oxide (Ni:Mn ratio=3:7, 0% Co, NCM 307), electrically conductive particles, and a polymer binder, while other cells included a positive electrode consisting of: an electroactive material consisting of nickel cobalt manganese aluminum oxide (NCMA), electrically conductive particles, and a polymer binder.

A first control electrolyte (CON1) was prepared consisting of: 1.2 Molar LiPF₆ in a mixture of FEC and DEC (FEC:DEC=1:4 vol/vol). Electrolytes in accordance with embodiments of the present disclosure were prepared by adding to the first control electrolyte tris(1,1,1,3,3,3-hexafluoropropan-2-yl) phosphate (1 wt %, 2 wt %, or 3 wt % THFPP) (THFPP-CON1) or 1 wt. % 2-(2,2,2-trifluoroethoxy)-1,3,2-dioxaphospholane 2-oxide (1 wt % TEDPO) (TEDPO-CON1).

A second control electrolyte (CON2) was prepared consisting of: 1 Molar LiPF₆ in a mixture of EC and DMC (EC:DMC=3:7 vol/vol), 2 wt % FEC, and 1 wt % VC. Electrolytes in accordance with embodiments of the present disclosure were prepared by adding to the second control electrolyte 2 wt % tris(1,1,1,3,3,3-hexafluoropropan-2-yl) phosphate (2 wt % THFPP) and 1 wt % LiDFOB (THFPP-LiDFOB-CON2).

During formation, the cells were charged to a potential of about 4.5 V, then subsequently discharged to 2.0 V. In the following cycles, the cells were cycled between 2.0 V and 4.4 V.

Cells including the NCM 307 positive electrode and the 1 wt % TEDPO-CON1 electrolyte had high areal capacity and higher normalized capacity retention than cells including the NCM 307 positive electrode and the CON1 electrolyte, indicating that the addition of TEDPO to FEC- and DEC-containing electrolytes can improve the electrochemical performance of batteries including lithium- and manganese-rich transition metal oxides as positive electrode materials.

Cells including the NCMA positive electrode and the 2 wt % THFPP-1 wt % LiDFOB-CON2 electrolyte had high areal capacity and higher normalized capacity retention than cells including the CON2 electrolyte, indicating that the addition of THFPP in combination with LiDFOB to EC-, DMC-, FEC-, and VC-containing electrolytes can improve the electrochemical performance of batteries including lithium nickel-rich transition metal oxides as positive electrode materials.

Cells including the NCM 307 positive electrode and the 2 wt % THFPP-CON1 electrolyte had high areal capacity and higher normalized capacity retention than cells including the 1 wt % THFPP-CON1 electrolyte and the 3 wt % THFPP-CON1 electrolyte, indicating that unexpectedly good results can be achieved by the addition of 2 wt % THFPP to FEC- and DEC-containing electrolytes of batteries including lithium- and manganese-rich transition metal oxides as positive electrode materials (instead of 1 wt % THFPP or 3 wt % THFPP).

Cells including the NCM 307 positive electrode and the 1 wt % THFPP-1 wt % LiPO₂F₂—CON1 electrolyte had high areal capacity and higher normalized capacity retention than cells including the 2 wt % THFPP-1 wt % LiPO₂F₂—CON1 electrolyte and the CON1 electrolyte, indicating that, when THFPP and LiPO₂F₂ are added to FEC- and DEC-containing electrolytes of batteries including lithium- and manganese-rich transition metal oxides as positive electrode materials, unexpectedly good results can be achieved by the addition of about 1 wt % THFPP (instead of 2 wt % THFPP).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a positive electrode comprising an electroactive material comprising a layered lithium transition metal oxide; and
an electrolyte infiltrating the positive electrode, the electrolyte comprising:
an organic solvent;
a lithium salt in the organic solvent; and
a fluorinated phosphate ester additive in the organic solvent, the fluorinated phosphate ester additive comprising at least one of:
(i) a chemical compound comprising a phosphate group attached to two or three branched-chain fluorocarbon groups, or
(ii) a chemical compound comprising a cyclic phosphate group attached to a fluorocarbon group.

2. The battery of claim 1, wherein the fluorinated phosphate ester additive comprises a fluorinated phosphate triester having the formula (1): 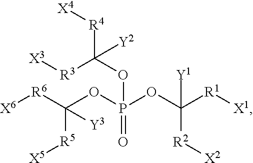
where X¹, X², X³, X⁴, X⁵, and X⁶ are each individually a fluorocarbon group, R¹, R², R³, R⁴, R⁵, and R⁶ are each individually a fluorinated or unfluorinated bivalent hydrocarbon group, and Y¹, Y², and Y³ are each individually hydrogen (H) or fluorine (F).

3. The battery of claim 2, wherein the fluorinated phosphate ester additive comprises tris(1,1,1,3,3,3-hexafluoropropan-2-yl) phosphate, tris(1,1,1,5,5,5-hexafluoropentan-3-yl) phosphate, tris(1,1,1,2,3,3,3-heptafluoropropan-2-yl) phosphate, or a combination thereof.

4. The battery of claim 1, wherein the fluorinated phosphate ester additive comprises a fluorinated cyclic phosphate ester having the formula (2): 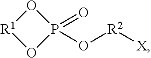
where R¹ is an unfluorinated bivalent hydrocarbon group, R² is a fluorinated or unfluorinated bivalent hydrocarbon group, and X is a fluorocarbon group.

5. The battery of claim 4, wherein the fluorinated phosphate ester additive comprises 2-(2,2,2-trifluoroethoxy)-1,3,2-dioxaphospholane 2-oxide.

6. The battery of claim 1, wherein the fluorinated phosphate ester additive constitutes, by weight, greater than or equal to about 0.5% to less than or equal to about 2.5% of the electrolyte.

7. The battery of claim 1, wherein the electroactive material of the positive electrode comprises a layered lithium- and manganese-rich transition metal oxide, and wherein the organic solvent comprises a mixture of fluoroethylene carbonate (FEC) and diethyl carbonate (DEC).

8. The battery of claim 7, wherein the lithium salt comprises lithium hexafluorophosphate (LiPF₆), and wherein the electrolyte further comprises lithium difluorophosphate (LiPO₂F₂).

9. The battery of claim 8, wherein the fluorinated phosphate ester additive constitutes, by weight, greater than or equal to about 0.5% to less than or equal to about 1.5% of the electrolyte, and wherein the LiPO₂F₂ constitutes, by weight, greater than or equal to about 0.5% to less than or equal to about 1.5% of the electrolyte.

10. The battery of claim 1, wherein the electroactive material of the positive electrode comprises a layered lithium nickel-rich transition metal oxide, and wherein the organic solvent comprises a mixture of ethylene carbonate (EC) and dimethyl carbonate (DMC).

11. The battery of claim 10, wherein the lithium salt comprises lithium hexafluorophosphate (LiPF₆) and lithium difluoro(oxalato)borate (LiDFOB), and wherein the electrolyte further comprises fluoroethylene carbonate (FEC) and vinylene carbonate (VC).

12. The battery of claim 11, wherein the fluorinated phosphate ester additive constitutes, by weight, greater than or equal to about 1.5% to less than or equal to about 2.5% of the electrolyte, the LiDFOB constitutes, by weight, greater than or equal to about 0.5% to less than or equal to about 1.5% of the electrolyte, the FEC constitutes, by weight, greater than or equal to about 1.5% to less than or equal to about 2.5% of the electrolyte, and the VC constitutes, by weight, greater than or equal to about 0.5% to less than or equal to about 1.5% of the electrolyte.

13. A battery that cycles lithium ions, the battery comprising:
a positive electrode comprising an electroactive material comprising a layered lithium transition metal oxide;
a negative electrode comprising an electroactive material comprising silicon oxide, lithiated silicon oxide, graphite, or a combination thereof; and
an electrolyte infiltrating the positive electrode and the negative electrode, the electrolyte comprising:
an organic solvent comprising a cyclic carbonate and a linear carbonate;
a lithium salt in the organic solvent; and
a fluorinated phosphate ester additive in the organic solvent, the fluorinated phosphate ester additive comprising at least one of:
(i) a chemical compound comprising a phosphate group attached to two or three branched-chain fluorocarbon groups, or
(ii) a chemical compound comprising a cyclic phosphate group attached to a fluorocarbon group.

14. The battery of claim 13, wherein the fluorinated phosphate ester additive comprises a fluorinated phosphate triester having the formula (1): 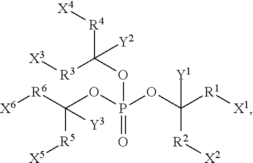
where X¹, X², X³, X⁴, X⁵, and X⁶ are each individually a fluorocarbon group, R¹, R², R³, R⁴, R⁵, and R⁶ are each individually a fluorinated or unfluorinated bivalent hydrocarbon group, and Y¹, Y², and Y³ are each individually hydrogen (H) or fluorine (F).

15. The battery of claim 14, wherein the fluorinated phosphate ester additive comprises tris(1,1,1,3,3,3-hexafluoropropan-2-yl) phosphate, tris(1,1,1,5,5,5-hexafluoropentan-3-yl) phosphate, tris(1,1,1,2,3,3,3-heptafluoropropan-2-yl) phosphate, or a combination thereof.

16. The battery of claim 13, wherein the fluorinated phosphate ester additive comprises a fluorinated cyclic phosphate ester having the formula (2): 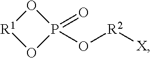
where R¹ is an unfluorinated bivalent hydrocarbon group, R² is a fluorinated or unfluorinated bivalent hydrocarbon group, and X is a fluorocarbon group.

17. The battery of claim 16, wherein the fluorinated phosphate ester additive comprises 2-(2,2,2-trifluoroethoxy)-1,3,2-dioxaphospholane 2-oxide.

18. The battery of claim 13, wherein the fluorinated phosphate ester additive constitutes, by weight, greater than or equal to about 0.5% to less than or equal to about 2.5% of the electrolyte.

19. The battery of claim 13, wherein the electroactive material of the positive electrode comprises a layered lithium- and manganese-rich transition metal oxide, the organic solvent comprises a mixture of fluoroethylene carbonate (FEC) and diethyl carbonate (DEC), the lithium salt comprises lithium hexafluorophosphate (LiPF₆), and the electrolyte further comprises lithium difluorophosphate (LiPO₂F₂), and wherein the fluorinated phosphate ester additive constitutes, by weight, greater than or equal to about 0.5% to less than or equal to about 1.5% of the electrolyte, and the LiPO₂F₂ constitutes, by weight, greater than or equal to about 0.5% to less than or equal to about 1.5% of the electrolyte.

20. The battery of claim 13, wherein the electroactive material of the positive electrode comprises a layered lithium nickel-rich transition metal oxide, the organic solvent comprises a mixture of ethylene carbonate (EC) and dimethyl carbonate (DMC), the lithium salt comprises lithium hexafluorophosphate (LiPF₆) and lithium difluoro(oxalato)borate (LiDFOB), and the electrolyte further comprises fluoroethylene carbonate (FEC) and vinylene carbonate (VC), and wherein the fluorinated phosphate ester additive constitutes, by weight, greater than or equal to about 1.5% to less than or equal to about 2.5% of the electrolyte, the LiDFOB constitutes, by weight, greater than or equal to about 0.5% to less than or equal to about 1.5% of the electrolyte, the FEC constitutes, by weight, greater than or equal to about 1.5% to less than or equal to about 2.5% of the electrolyte, and the VC constitutes, by weight, greater than or equal to about 0.5% to less than or equal to about 1.5% of the electrolyte.
